(19) United States
(12) Patent Application Publication
(10) Pub. No.: US 2024/0396851 A1
(43) Pub. Date: Nov. 28, 2024

(54) COMMUNICATION DEVICE, COMMUNICATION METHOD, AND STORAGE MEDIUM

(71) Applicant: DENSO CORPORATION, Kariya-city (JP)

(72) Inventor: Satoshi YOSHINAGA, Kariya-city (JP)

(21) Appl. No.: 18/792,361

(22) Filed: Aug. 1, 2024

Related U.S. Application Data
(63) Continuation of application No. PCT/JP2022/042853, filed on Nov. 18, 2022.

(30) Foreign Application Priority Data
Feb. 3, 2022 (JP) 2022-015901

(51) Int. Cl. H04L 47/36; H04L 47/28; H04L 47/30; H04N 19/10

(52) U.S. Cl. CPC H04L 47/365; H04L 47/28; H04L 47/30; H04N 19/10

(57) ABSTRACT

A communication device for transmitting packets received from a first device to a second device using a plurality of communication lines, have a receiving unit for receiving packets, a packet identification unit for identifying chunks, a communication performance acquisition unit for acquiring the communication performance of the plurality of communication lines, the transmission control unit that assigns, for each of the chunks, each of the plurality of packets to one of the communication lines to make the arrival time of the plurality of packets by the chunk to the second device the earliest.

### CROSS-REFERENCE TO RELATED APPLICATION

The present application is a continuation application of International Application No. PCT/JP2022/042853, filed on Nov. 18, 2022, which claims priority to Japanese Patent Application No. 2022-015901, filed on Feb. 3, 2022. The contents of these applications are incorporated herein by reference in their entirety.

### BACKGROUND

### 1. Technical Field

This disclosure relates to a communication device, a communication method, and a storage medium.

### 2. Related Art

In a multi-carrier communication device with multiple communication lines, in which the communication performance of each communication line differs, the communication time differs depending on which communication line is used to send packets. Therefore, the communication time can be shortened by assigning packets to communication lines according to the communication performance of each communication line.

### SUMMARY

A communication device according to an aspect of the present disclosure transmits a packet received from a first device to a second device using one of a plurality of communication lines. The communication device has a receiver that receives the packet from the first device, a packet identifier that identifies a chunk to which each of the packets belongs, the chunk being a unit of data treated as a single piece of data at a higher layer, a buffer that stores the packets, a communication performance acquisition unit that acquires the communication performance of each of the plurality of communication lines, a transmission control unit that assigns, for each chunk, a plurality of packets belonging to the chunk to respective one of the plurality of communication lines based on the communication performance of each of the plurality of communication lines to make the arrival time of the plurality of packets as the whole chunk to the second device the earliest, and a transmitter that reads the packets from a buffer and transmits the read packets to the second device using one of the plurality of communication lines based on the assignment by the transmission control unit.

A communication method according to another aspect of the present disclosure, which is performed by a communication device and transmits a packet received from a first device to a second device using one of a plurality of communication lines, includes; receiving the packets from the first device, identifying the chunk to which each of the packets belongs, the chunk being a unit of data treated as a single piece of data at a higher layer, storing the packet in a buffer, acquiring the communication performance of each of the plurality of the communication lines, assigning, for each of the chunks, each of a plurality of the packets to respective one of the plurality of the communication lines based on the communication performance, to make the arrival time of the plurality of packets as the whole chunk to the second device the earliest, and reading the packets from the buffer and transmitting the read packets to the second device using one of the plurality of the communication lines based on the assignment.

The storage medium according to another aspect of the present disclosure is a computer-readable non-transitory storage medium storing a communication program executable by a communication device. The communication device transmits packets received from the first device to the second device using one of a plurality of communication lines. The communication program causes the communication device to: receive the packets from the first device, identify the chunk to which each of the packets belongs, the chunk being a unit of data treated as a single piece of data at a higher layer, store the packet in a buffer, acquire the communication performance of each of a plurality of the communication lines, assign, for each of the chunks, each of a plurality of the packets to respective one of a plurality of the communication lines based on the communication performance, to make the arrival time of the plurality of packets as the whole chunk to the second device the earliest, and read the packets from the buffer and transmit the read packets to the second device using one of the plurality of the communication lines based on the assignment.

### BRIEF DESCRIPTION OF THE DRAWINGS

In the accompanying drawings:

FIG. 1 shows the configuration of the communication device of the first embodiment;

FIG. 2 illustrates the packet information stored in the packet information storage of the communication device of the first embodiment;

FIG. 3 shows a specific example of operation of the packet identification unit of the communication device of the first embodiment;

FIG. 4 is an example of the IP header;

FIG. 5 shows an example of the TCP/UDP payload of the packet;

FIG. 6A shows how packets are assigned in the conventional example;

FIG. 6B illustrates the packet allocation method of this embodiment;

FIG. 7 is an illustration of a first specific example of the allocation method performed by this embodiment;

FIG. 8 is an illustration of second specific example of the allocation method performed by this embodiment;

FIG. 9 is a flowchart showing the operation of the communication device of the first embodiment;

FIG. 10 is a configuration diagram of a communication device according to a modification of the first embodiment;

FIG. 11 shows the configuration of the communication device of the second embodiment;

FIG. 12 shows a specific example of operation of the packet identification unit of the communication device of the second embodiment;

FIG. 13 illustrates the packet information stored in the packet information storage of the communication device of the second embodiment; and

FIG. 14A shows a first specific example of combinations of source device, communication device, and destination device;

FIG. 14B shows a second specific example of combinations of source device, communication device, and destination device; and

FIG. 14C shows a third specific example of combinations of source device, communication device, and destination device.

### DETAILED DESCRIPTION OF THE PREFERRED EMBODIMENTS

JP2000-134715A (published unexamined patent application) discloses that it is possible to distribute the amount of communication load transmitted by each of multiple communication lines according to the communication status. The communication status includes the communication performance of multiple communication lines, the amount of un-transmitted data, and the amount of unanswered data. The unanswered data is data for which a response has not been received from the destination.

In the invention described in JP2000-134715A, communication lines are assigned to packets so that the time required to complete transmission of un-transmitted data is minimized, however communication lines are not assigned to packets considering chunks which each of the packets belongs to. The chunks are data units in the higher layers of the OSI reference model. As a result, data is not necessarily available earlier to the receiving device that received the packets.

The purpose of this disclosure is to realize a communication device, etc. that can make the receiving device use data more quickly by an efficient data transmission.

The present disclosure enables efficient data transmission that allows faster use of data at the receiving device.

Embodiments of the present disclosure are described below with reference to the drawings.

The present invention means the invention described in the claims and is not limited to the following embodiments. Words and phrases in double quotation marks refer to the words and phrases described in the claims, and likewise are not limited to the following embodiments.

The configurations and methods described in the dependent claims are optional configurations and methods of the invention described in the independent claims. Configurations and methods of embodiments corresponding to the configurations and methods described in the dependent claims, as well as configurations and methods not described in the claims but only in the embodiments, are optional configurations and methods of the present invention. The configurations and methods described in the embodiments in cases where the claims are broader than the description of the embodiments are also optional configurations and methods in the present invention in the sense that they are examples of the configurations and methods of the invention. In either case, the description in the independent claims is an essential configuration and method of the invention.

The effects described in the embodiments are those of having the configuration of the embodiments as an example of the invention and not necessarily those of the invention.

If there are multiple embodiments (including variations), the configuration disclosed in each embodiment is not limited to the embodiment only but can be combined across embodiments. For example, the configuration disclosed in one embodiment can be combined with other embodiments. Also, configurations disclosed in each of multiple embodiments can be partially collected and combined.

The problems described in this disclosure are not publicly known but were independently discovered by the inventor. The problems described in this disclosure affirm the inventive step of the invention together with the composition and method described in this disclosure.

### 1. The First Embodiment

### (1) Overall Configuration of Communication Device 100

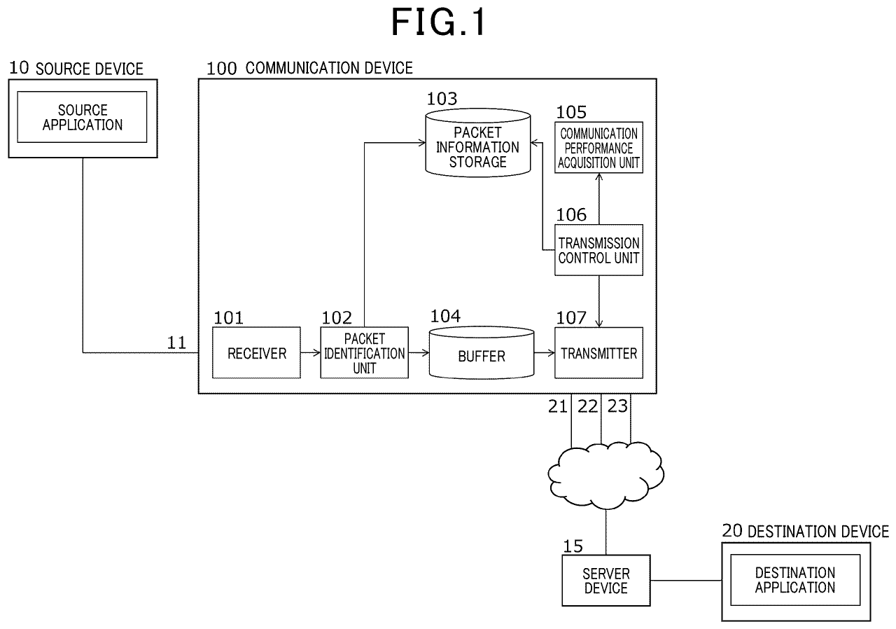

FIG. 1 illustrates the configuration of the communication device 100 of the first embodiment. The communication device 100 includes a receiver 101, a packet identification unit 102, a packet information storage 103, a buffer 104, a communication performance acquisition unit 105, a transmission control unit 106, and a transmitter 107.

The communication device 100 may include, for example, a general-purpose central processing unit (CPU), volatile memory such as RAM, nonvolatile memory such as ROM, flash memory, hard disk, various interfaces, and an internal bus connecting these devices. For example, the communication device 100 executes software using this hardware to perform the functions of each functional block described in FIG. 1. The communication device 100 may be realized with dedicated hardware such as an LSI. The above description is also true for other forms of communication devices. In this embodiment, it is assumed the communication device 100 has the form of an electronic control unit (hereinafter abbreviated as ECU) as a semi-finished product, but it is not limited to this form. For example, semiconductor circuits and semiconductor modules may be assumed as the component form, electronic control units, and system boards as the semi-finished product form, and servers, workstations, personal computers (PCs), tablets, mobile routers, smart phones, cell phones, and navigation systems as the finished product form. The communication device 100 may include multiple ECUs instead of a single ECU. The communication device 100 may be a Telematics Control Unit (TCU). The above description is also true for other forms of communication devices.

The receiver 101 receives “packets” generated by the source device 10 (an example of the “first device”). The packet is, for example, data generated by the source application running on the source device 10, divided into multiple packets by packetization or fragmentation performed by the control unit or other unit of the source device 10 (not shown in the figure), and then transmitted to the communication device 100. A “packet” is a piece of data that is a unit of transmission in information communication, and can be called by any name, such as frame, segment, etc., in addition to “packet” in a narrow sense.

The source application generates data. A video transmission application is an example of the source application. The video transmission application compresses image data captured by a camera connected to the source device 10 into I-frame, P-frame, and B-frame data based on, for example, the H.264/MPEG4 AVC standard and transmits it to a destination application in the destination device 20. In this case, each compressed frame data is fragmented by the network card (NIC: Network Interface Card) of the source device 10 to be divided into packets of the MTU (Maximum Transmitter) size of the NIC and transmitted. The packets are then sent.

The source device 10 and the communication device 100 are connected to each other via communication line 11. The communication line 11 may be either a wireless communication path or wired communication line. Examples of the wireless communication path include communication paths based on mobile communication systems. For example, the wireless communication path is a communication line based on a wireless communication system such as W-CDMA (Wideband Code Division Multiple Access), HSPA (High Speed Packet Access), LTE (Long Term Evolution), LTE-A (Long Term Evolution Advanced), 4G, or 5G. Other wireless communication paths are, for example, IEEE802.11 (Wi-Fi), IEEE802.16 (WiMAX), Bluetooth, UWB (Ultra-Wide Band), or DSRC (Dedicated Short-Range Communication) and other wireless communication methods. The wired communication lines include, for example, LAN (Local Area Network) such as Ethernet, optical lines, or fixed telephone lines. In the case of in-vehicle device, for example, CAN (Controller Area Network) or LIN (Local Interconnect Network), which are in-vehicle networks, are used as the wired communication lines. In addition, communication line 11 may be a combination of the wireless communication path and wired communication lines.

The form of the transmission source device 10 may be a component, a semi-finished product, or a finished product, as well as the communication device 100. The specific form of the transmission source device 10 is described below.

The packet identification unit 102 obtains packet information by analyzing packets received by the receiver 101 and stores the obtained packet information in the packet information storage 103. Also, the packet identification unit 102 identifies the chunk to which the packet received by the receiver 101 belongs. A chunk is a data unit that is treated as a single piece of data in the higher layers. Higher layers are layers which are the transport layer (Layer 4) or above the transport layer when packets are communicated in network layer (Layer 3) of the OSI reference model. An example of a chunk is compressed frame data (I-frames, P-frames, or B-frames) when the source application of the transmitting terminal device 10 is a video transmission application.

In addition to this, the packet identification unit 102 obtains packet size, chunk size, and importance information of received packets by analyzing the packets. The specific chunk identification and chunk numbering methods performed by the packet identification unit 102 are described below.

The packet information storage 103 stores packet information obtained by the packet identification unit 102. For example, the packet information storage 103 stores packet information input from the packet identification unit 102 in the order of input. The packet information storage 103 may have either nonvolatile memory or volatile memory.

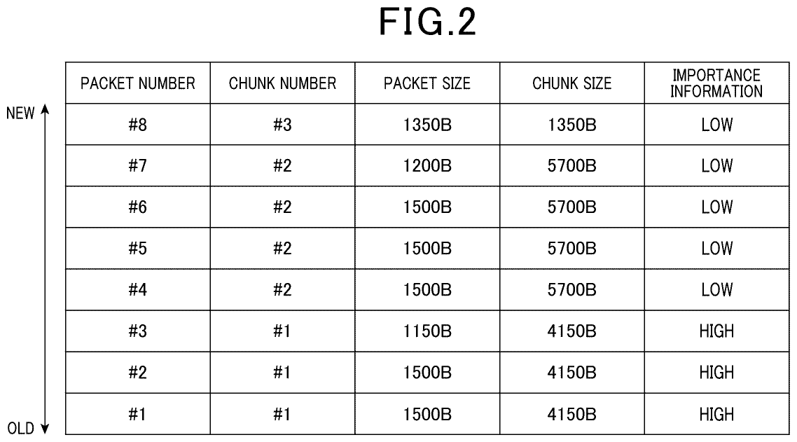

FIG. 2 shows packet information stored in the packet information storage 103. The packet number is a serial number assigned by the packet identification unit 102 for each packet received by the receiver 101 in the order received by the receiver 101.

The chunk number is a serial number that identifies the chunk to which each packet belongs. The chunk number is assigned by the packet identification unit 102 by analyzing each packet received by the receiver 101.

The packet identification unit 102 obtains the packet size for each packet received by the receiver 101. In a case that the packet size is listed in the identification information such as the IP header, the packet size included in the identification information is recorded. In a case that the packet received by the receiver 101 is a fixed-length packet, the predetermined fixed-length packet size is recorded.

The chunk size is the size of the chunk identified by the packet identification unit 102. The chunk size is obtained, for example, by summing the packet sizes of packets assigned the same chunk number. Specifically, the chunk size is obtained as follows.

In the example in FIG. 2, when packet #1 (chunk number #1) is received, there is still only one packet with chunk number #1, so 1500B, the same as the packet size, is recorded for the chunk size of packet #1. When packet #2 (chunk number #1) is next received, there will be two packets with chunk number #1, so the chunk size of packet #1 and packet #2 will be recorded as 3000B, which is the earlier chunk size of 1500B plus the packet size of packet #2. Furthermore, when packet #3 (chunk number #1) is received, there will be three packets with chunk number #1, so the chunk size of packet #1 through packet #3 will be recorded as 4150B, adding the packet size of packet #3 (1150B) to the earlier chunk size of 3000B. When packet #4 (chunk number #2) is received, the chunk number of packet #4 is different from the chunk numbers of packets #1 through #3 received earlier, so 1500B, the same as the packet size, is recorded for the chunk size of packet #4. Hereafter, the chunk size is recorded for each packet input by the same calculation.

The importance information is information indicating the importance of the packet. Specifically, the importance information is information assigned to each packet by the source device 10 or information assigned by the packet identification unit 102 by analyzing the packet based on the contents of the payload data of the packet. The importance of a packet may be defined according to the purpose of the source application or the purpose of the installation of the communication device 100. For example, in a case that the packet is video image data, the importance of packets including I-frames may be raised above the importance of packets including other types of frames because missing I-frames would prevent decoding of P-frames and B-frames. Alternatively, in a case that the communication device 100 is an in-vehicle device installed in an automobile, the importance of information directly indicating the driving status, such as speed and acceleration, may be raised above the importance of other information. In FIG. 2, the importance information is shown as two values (“High” or “Low”), but the importance information may be defined in three or more levels.

The packet information stored in the packet information storage 103 may be updated according to the processing status of packets stored in the buffer 104 described below. For example, when a packet is stored in the buffer 104, the packet information of the stored packet is recorded in the packet information storage 103. When a packet is discarded from the buffer 104, the packet information of the discarded packet is deleted from the packet information storage 103. When the transmitter 107 reads a packet from the buffer 104 and transmits it, the packet information of the read packet is deleted from the packet information storage 103.

The buffer 104 stores packets received by receiver 101 and whose chunks are identified by packet identifier 102. Specifically, the buffer 104 stores packets received by receiver 101 in the order of receipt, excluding those that are discarded. Like the packet information storage 103, the buffer 104 may be composed of either nonvolatile memory or volatile memory. The buffer 104 is an area for storing packets, and the packets in the buffer 104 may be stored or read in an arbitrary order. The buffer 104 may include a queue and/or a stack.

In this implementation, the buffer 104 is controlled based on FIFO (First In First Out) operation, which stores the packets in input order and outputs packets in the input order, and may be referred to as a queue. However, in this implementation, the output order may not necessarily be the input order.

The transmitter 107 reads the packets from the buffer 104 and transmits the read packets to the server device 15 (an example of a “second device”) or to the destination device 20 (another example of “second device”) via the server device 15, using one of the plurality of communication lines based on the assignment by the transmission control unit 106 described below. The plurality of communication lines includes, for example, three communication lines, including a communication line 21, a communication line 22, and a communication line 23. The order in which packets are read is in principle the same as the input order of buffer 104 but may not necessarily be the same as the input order. The transmitted packets are used by the destination application in the destination device 20.

The destination application uses the data contained in the packet. For example, the destination application is image playback software that decodes and plays back compressed image data.

The form of the destination device 20 may be a component, semi-finished product, or finished product, as with the communication device 100. The specific form of the destination device 20 is described below.

The communication device 100 and the server device 15 are connected to each other via the plurality of communication lines. The server device 15 is connected to the Internet or the like via a base station device, gateway device, or the like connected to the plurality of communication lines.

Each of communication line 21, communication line 22, and communication line 23 may be a wireless communication path or a wired communication line. Examples of the wireless communication path and the wired communication lines are the same as those described as examples of communication line 11. Also, the communication line may be a combination of the wireless communication path and the wired communication line. For example, in a case that the server device 15 is connected to the Internet, communication between the communication device 100 and the base station device may be performed using a 4G or 5G wireless communication system, and communication between the base station device and the server device 15 may be performed using a wired communication system with optical fiber.

For example, communication line 21 is 5G, communication line 22 is LTE, and communication line 23 is Wi-Fi. In this embodiment, there are three examples of the plurality of communication lines, but there may be two or four or more communication lines. All or part of the plurality of communication lines may be the same communication system.

In a case that the destination device 20 can be connected by the plurality of communication lines, the transmitter 107 may send the read packets directly to the destination device 20 without going through the server device 15.

The server device 15 rearranges the packets received from the communication device 100 and sends them to the destination device 20. The server device 15, for example, rearranges the packets according to the order of the packet numbers of the received packets.

The communication performance acquisition unit 105 acquires the “communication performance” of each of the plurality of communication lines: communication line 21, communication line 22, and communication line 23. “Communication performance” is the communication performance of each of the communication line. The “communication performance” may vary due to the communication line itself, or due to the various devices used to realize communication over the communication line.

In this embodiment, the communication performance acquisition unit 105 acquires, as communication performance, the available bandwidth, which is the bandwidth that can be used for communication, and the line delay, which is the time taken from transmission to reception. As an alternative, or in addition, the communication performance acquisition unit 105 may acquire the communication speed (bit rate) and/or round-trip delay time (round trip time (RTT)) as communication performance. The communication performance acquisition unit 105 may acquire these communication performances using known techniques.

For each chunk which corresponding packets are stored in buffer 104, transmission control unit 106 determines which of the plurality of packets belonging to the chunk is to be transmitted via which of the plurality of communication lines. The transmission control unit 106, based on the communication performance acquired by the communication performance acquisition unit 105, for each chunk, assign each of the plurality of packets to one of the communication lines 21, 22, and 23, so that the arrival time of the last packets belonging to the same chunk to the server device 15 or the destination device 20 (whichever is “second device”) is earliest. Here, making the arrival time the earliest includes not only the case where the arrival time is the earliest based on time, but also the case where the arrival time is the earliest as because of making time to complete transmission or reception the shortest.

The specific method of allocating packets to the communication line performed by the transmission control unit 106 is described below.

In addition to the communication performance, at least one of the following may be used for the allocation in the transmission control unit 106: (A) the amount of un-transmitted data in the chunk being transmitted, (B) the amount of data that is being transmitted or scheduled to be transmitted on each communication line but has not yet reached the “second device,” and (C) the amount of inflight data (the amount of data that has not yet been sent to the “second device”). These amounts can be derived based on the packet information stored in the packet information storage 103.

### (2) Details of the Packet Identification Unit 102 of the Communication Device 100 of this Embodiment

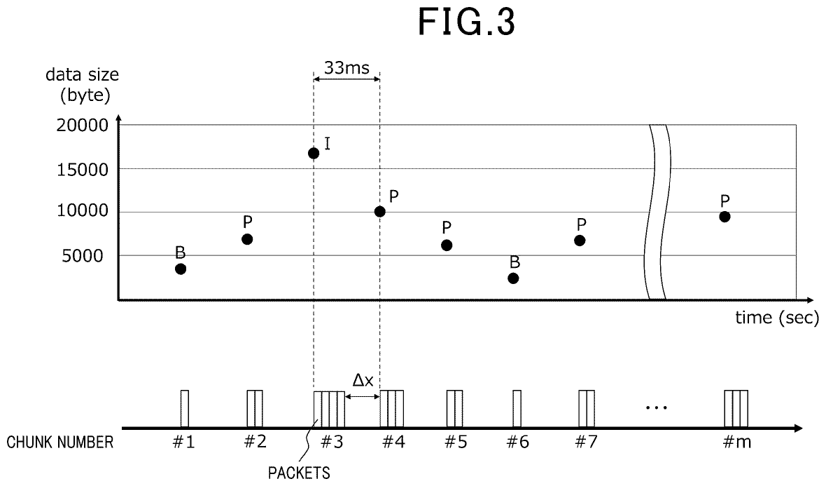

Each of FIGS. 3-5 illustrates examples of specific chunk identification and chunk numbering methods performed by the packet identification unit 102.

### (a) An Example of Identification of Chunks Based on the Interval of Packet Reception

FIG. 3 illustrates an example of identifying chunks based on the interval of packet reception. In this example, the packet identification unit 102 identifies chunks based on the reception interval of packets received by the receiver 101.

When the video transmission application of the transmitting terminal device 10 compresses images and transmits frames, the transmitting terminal device 10 divides each frame into single or multiple packets and transmits the frames as shown in FIG. 3. If the frame rate is 30 FPS (Frames Per Second), each frame is divided into multiple packets and transmitted by frame every 1/30 s=33 ms. Since the packets in a single frame are continuously transmitted in bursts, the transmission interval between packets is very small. In contrast, in case of spanning frames, the time between the transmission of the last packet in the previous frame and the transmission of the first packet in the next frame (Δx) is some wide transmission interval. On the other hand, since the amount of data in an I-frame is larger than that in a P- or B-frame, the transmission interval between an I-frame and another frame or a sequence of I-frames is smaller.

The packet identification unit 102 uses, for example, 5 ms as a threshold to enable correct determination even when I-frames are consecutive. If Δx is smaller than 5 ms, the packets are determined to belong to the same frame, and if Δx is greater than or equal to 5 ms, the packets are determined to belong to different frames. Each frame is then identified as one chunk, and packets belonging to the same chunk are assigned the same chunk number, and when the new chunk is started, the chunk number is assigned incrementally. In the example in FIG. 3, the packet identification unit 102 assigns #1, #2, . . . #m as the chunk number in the order of reception. Based on the chunk number, it is possible to identify which chunk the packet belongs to.

In the example in FIG. 3, video compression using the H.264/MPEG4 AVC standard is used as an example, but the same applies when still image compression (e.g., JPEG standard) is used.

### (b) An Example of Identification of Chunks Based on the IP Header of a Packet

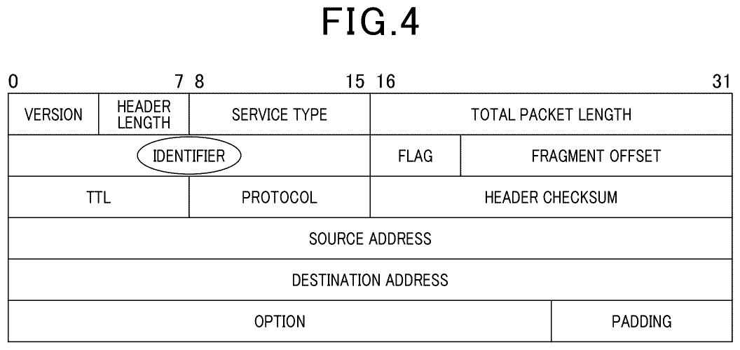

FIG. 4 illustrates an example of the IP header. In this example, the packet identification unit 102 identifies chunks based on the identifier in the IP header of the packet.

The IP header shown by FIG. 4 contains information about the packet. For example, in a case that the source device 10 attempts to send a large frame data in a single packet, NIC performs fragmentation of the frame data, and the frame data is divided into multiple packets. In this case, the IP header of each packet originating from the same frame is assigned the same identifier. When a frame transmitted by the source terminal device 10 is defined as a chunk, the packet identification unit 102 can identify which chunk the packet belongs to, based on the identifier in the IP header. In this implementation, the packet identification unit 102 assigns the same chunk number to the packets which have the same IP header identifier and increment the chunk number when the IP header identifier has changed.

### (c) An Example of Identification of Chunks Based on Packet Payload Data

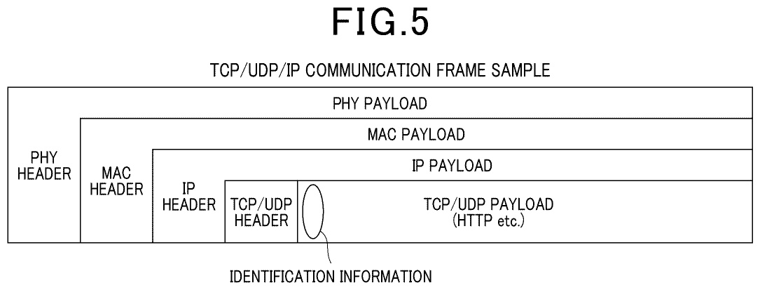

FIG. 5 illustrates an example of the TCP/UDP payload of the packet. In this example, the packet identification unit 102 identifies chunks based on the identification information contained in the TCP/UDP payload of the packet.

When large size data is packetized into small size packets by the source application, the source application stores identification information indicating the data before splitting at the beginning of the TCP/UDP payload. When data transmitted by the source terminal device 10 is defined as a chunk, the packet identification unit 102 can identify which chunk the packet belongs to, based on the identification information in the TCP/UDP payload. In this implementation, the packet identification unit 102 increments and assigns a chunk number to each TCP/UDP payload identification information.

### (d) Other Example of Identification of Chunks

The packet identification unit 102 may identify chunks from the timestamp when they are stored in the buffer 104. In a case that video compression is used, and I-frame, P-frame, and B-frame information is recorded in the packet, the packet identification unit 102 may identify chunks based on this information.

### (3) Details of the Transmission Control Unit 106 of the Communication Device 100 of this Embodiment

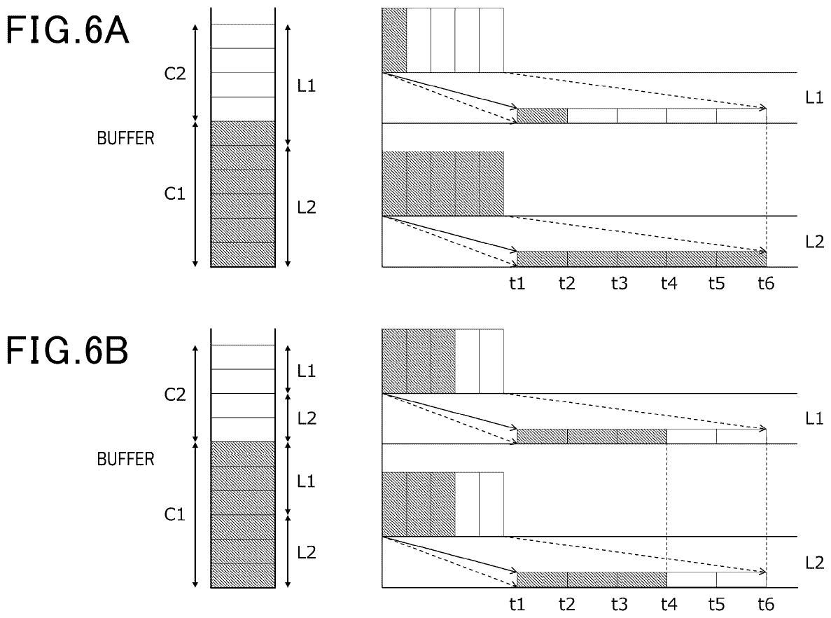

Examples of specific methods of allocating packets to communication lines performed by the transmission control unit 106 are described using FIGS. 6-8.

(a) Comparison with Conventional Examples

FIG. 6A and FIG. 6B compares the overview of the allocation method in the conventional example with the overview of the allocation method of the transmission control unit 106 in this implementation. FIG. 6A shows how packets are assigned in the conventional example. In the conventional example, packets are not assigned to communication lines from the perspective of chunks, but the term “chunk” is used in the conventional example to explain the effect of this method in comparison with the present method.

Buffer 104 already contains packets corresponding to chunk 1 (C1 in the drawing) and chunk 2 (C2 in the drawing). Assume the case in which these packets are to be sent by distributing them to communication line L1 and communication line L2. For simplicity, FIG. 6A and FIG. 6B assumes that the available bandwidth and line delay of communication lines L1 and L2 are the same.

As FIG. 6A shows, when packets are sent by sorting them into communication lines L1 and L2 without distinguishing the chunk to which they belong, the arrival completion time of packets belonging to chunk 1 and packets belonging to chunk 2 are both at t6. In other words, the destination application can use the data in chunk 1 and chunk 2 at the destination device 20 after t6.

FIG. 6B illustrates the packet allocation method of this embodiment. For each chunk, the transmission control unit 106 assigns each of the multiple packets to either communication line L1 or communication line L2, so that the arrival time of the multiple packets belonging to each chunk to the destination device 20 is the earliest. In the example in FIG. 6B, the transmission control unit 106 assigns three packets each belonging to chunk 1 to communication lines L1 and L2. It also assigns packets belonging to chunk 2 to communication lines L1 and L2, 2 packets each. As a result, the arrival completion time of packets belonging to chunk 2 is t6, which is the same as the conventional case shown in FIG. 6A, but the arrival time of packets belonging to chunk 1 is t4. In this situation, the destination application can use the data in chunk 1 at the destination device 20 after t4, and the destination application can use the data in chunk 1 earlier than in the conventional example. This is especially effective for data with real-time characteristics. In other words, this is effective when the destination application is an application that values real-time performance.

Thus, according to this embodiment, for each chunk, multiple packets belonging to a chunk are assigned to each communication line so that the arrival time of the packets is the earliest, so that the arrival completion time can be optimized for each chunk.

The conventional method of reading packets from buffer 104 and allocating them in a round-robin fashion may be used instead of the allocation method shown in FIG. 6A, but in a simple round-robin fashion. If the communication performance of each line differs, the time required to complete transmission of each chunk will be dictated by the performance of the slowest line (for example, a line with a narrow available bandwidth or a line with high line delay). The performance of a slow line (e.g., a line with a small usable bandwidth or a line with a large line delay) determines the time required to complete the transmission of each chunk. For example, even if packet reading is performed using weighted round robin based on the remaining size of buffer 104, available bandwidth, and line delay, it is only possible to transmit all packets stored in buffer 104 in the shortest possible time, not necessarily each chunk in the shortest possible time. It is not always possible to transmit each chunk in the shortest possible time. This inconvenience, as in the case of simple round robin, is especially noticeable when the communication performance of each line is different, especially when there are lines with significantly lower communication performance than the other lines.

(b) A First Specific Example of the Allocation Method of this Embodiment

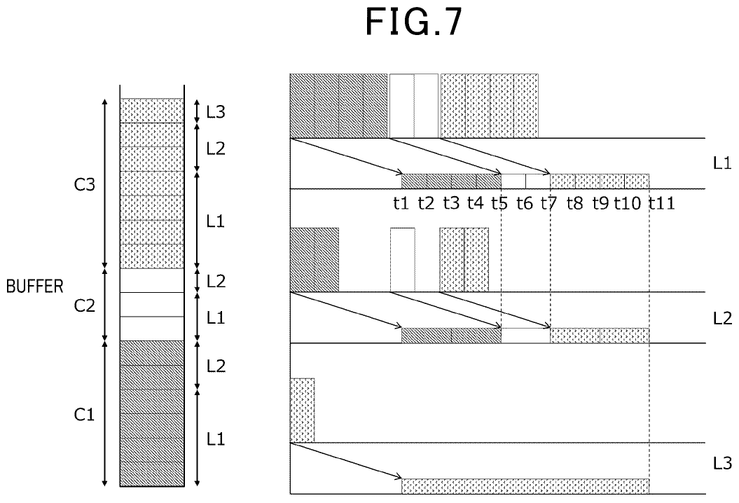

FIG. 7 illustrates the first specific example of the allocation method performed by the transmission control unit 106. In FIG. 7, packets are transmitted using communication line L1, communication line L2, and communication line L3. For simplicity, FIG. 7 assumes that the available bandwidth of communication line L1 is 100 Mbps, that of communication line L2 is 50 Mbps, and that of communication line L3 is 10 Mbps, and that the line delay of each communication line is the same between communication lines.

The transmission control unit 106 first assigns each of the multiple packets to one of the communication lines so that the arrival time of the six packets belonging to chunk 1 to the destination device 20 is the earliest. Considering the difference in available bandwidth or the ratio of available bandwidth of each communication line, by assigning four packets to communication line L1 and two packets to communication line L2, the packets belonging to chunk 1 arrive at the destination device 20 at t5, which is the earliest arrival time. Note that packets belonging to chunk 1 are not assigned to communication line L3. This is because the available bandwidth of communication line L3 is small, and if packets were assigned to communication line L3, the packets belonging to chunk 1 would arrive at the destination terminal 20 at t11, which is not the earliest arrival time.

Next, the transmission control unit 106 assigns each of the multiple packets to one of the communication lines so that the arrival time of the three packets belonging to chunk 2 to the destination device 20 is the earliest. Considering the time required for delivery of packets belonging to chunk 1, which has already been assigned, and the difference or ratio of the available bandwidth of each communication line, by allocating two packets to communication line L1 and one packet to communication line L2, the arrival time of packets belonging to chunk 2 to the destination device 20 is t7 and the arrival time is the earliest. Again, no packets belonging to chunk 2 are assigned to communication line L3. This is because the available bandwidth of communication line L3 is small, and if packets were assigned to communication line L3, the packets belonging to chunk 1 would arrive at the destination device 20 at t11, which is not the earliest arrival time.

Furthermore, the transmission control unit 106 assigns each of the multiple packets to one of the communication lines so that the arrival time of the seven packets belonging to chunk 3 to the destination device 20 is the earliest. Considering the time required for delivery of packets belonging to chunks 1 and 2 that have already been assigned, and the difference or ratio of the available bandwidth of each communication line, allocating four packets to communication line L1, two packets to communication line L2, and one packet to communication line L3 will result in the packet arriving at the destination device 20 at t11, which is the earliest arrival time.

It is sufficient to determine the data size to be transmitted over each communication line for each chunk, and it is not necessary to specify the communication line to be used for transmission of each packet. If the packets stored in the buffer are fixed-length packets, determining the data size to be transmitted over each communication line for each chunk is equivalent to determining the number of packets to be sent over each line for each chunk. Therefore, as shown in FIG. 7, packets belonging to chunk 1 may be continuously transmitted over the same line in the order in which they are retrieved from the buffer like, L1, L1, L1, L1, L1, L2, L2, alternatively packets belonging to chunk 1 may be transmitted in accordance with a weighted round-robin fashion like L1, L1, L2, L1, L1, L2, or L2, L1, L1, L2, L1, L1 so that each line may be selected alternately for transmitting.

In the case of variable length packets, the size of each packet is considered, and each packet is assigned to each communication line.

The packets assigned to communication line L3 among the packets belonging to chunk 3 (an example of “subsequent chunks”), are desirable to start being transmitted while the packets of chunk 1 and chunk 2 (an example of “preceding chunks”) are being transmitted. The packets of chunk 1 and chunk 2 should be arrived at the “second device” earlier than the packets of chunk 3. The transmitter 107, when transmitting a packet of chunk 3 from communication line L3 to which a packet of chunk 3 (an example of “subsequent packet”) has been assigned, may read the packet from a position offset from the top of buffer 104. In FIG. 7, the transmitter 107 reads out the packet in chunk 3 that is located farthest from the top of the buffer.

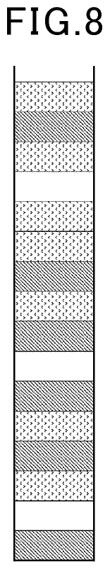

Furthermore, as shown in FIG. 8, if the packets stored in buffer 104 are not necessarily arranged in chunk order, the transmission control unit 106 may be instructed to read from buffer 104 in chunk number order by referring to the chunk number in the packet information storage 103. In this case, buffer 104 should not be FIFO (First In First Out), but rather read from a desired position by setting an offset as appropriate.

(c) Second Specific Example of the Allocation Method of this Embodiment

In the first specific example of the allocation method of this embodiment, the available bandwidth of each communication line and the line delay, which is the delay time of each communication line, were used as the communication performance, but other communication performance may be used. For example, the communication speed (bit rate) of each communication line may be used as the communication performance. In addition to the communication performance, the transmission control unit 106 may use at least one of the amount of un-transmitted data and the amount of in-flight data of the chunk being transmitted for allocation to the communication line. An example of the allocation method of the transmission control unit 106 when these parameters are used is described below.

First, for each of the plurality of communication lines, the transmission control unit 106 calculates the time required to complete the transmission of the data of the chunks to be transmitted on a single line using the available bandwidth of each communication line, the line delay of each communication line, the amount of un-transmitted data of the chunk being transmitted, and the amount of in-flight data of each communication line. The transmission control unit 106 evaluates which line is the fastest line in order of the time required to complete transmission of the data of the chunks to be transmitted.

Next, the transmission control unit 106 calculates the time required to complete the transmission of a chunk of data when the number of communication lines used to transmit the chunk of data is increased in order from the fastest communication line, using the available bandwidth of each communication line, the line delay of each communication line, the amount of un-transmitted data of the chunk being transmitted, and the amount of in-flight data of each communication line. Then the transmission control unit 106 calculates the shortest time (shortest), which is the time required to complete transmission, and the number of lines used (usage) to achieve the shortest time are calculated using the available bandwidth of each communication line, the line delay of each communication line, the amount of un-transmitted data for the chunk being transmitted, and the amount of in-flight data for each communication line.

Then, the transmission control unit 106 calculates the amount of data to be transmitted through each communication line based on the shortest time (shortest), the available bandwidth of each communication line, the line delay of each communication line, and the amount of in-flight for each communication line for the number of lines used (usage) in order from the fastest communication line. The transmission control unit 106 does not transmit the data of the chunk to be transmitted via communication lines that are not included in the number of lines in use (usage).

The transmission control unit 106 repeats the above calculation for each chunk. In the calculation for subsequent chunks, the transmission control unit 106 performs calculations based on the results of the calculation of the amount of data transmitted via each communication line for the preceding chunk, considering the amount of data that has not yet been transmitted even though the allocation to each communication line has been determined. When a communication line that was not included in the number of lines used (usage) when calculating the amount of data transmitted via each communication line for the preceding chunk, that is, a communication line that was not used for data transmission of the preceding chunk, is used for data transmission of the following chunk, the transmitter 107 reads the following packets belonging to the following chunk from a position offset from the top of the buffer 104. This is because in between the top of the buffer 104 and the position before the offset position, the preceding packets must be contained.

### (d) Sub-Clause

The above describes the allocation method of the transmission control unit 106. The one-way delay time or RTT can be used as the line delay. If the acknowledgment is sent using all communication lines, the line delay can be the delay time required for uplink communication on the target communication line plus the downlink communication delay time of the communication line with the shortest downlink communication delay time. The transmitter 107 may also perform congestion control, such as BBR, or flow control as appropriate in the transmission of packets. Some of the control methods described in the first specific example of the allocation method of this embodiment may be applied to the second specific example of the allocation method of this embodiment.

### (4) Operation of this Embodiment

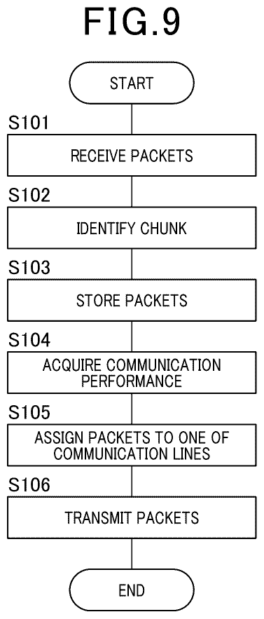

FIG. 9 is used to explain the operation of this form of communication device 100. The following operations not only show the communication method in the communication device 100, but also the processing steps of the communication program executed in the communication device 100. Additionally, these processes are not limited to the order shown in FIG. 9. In other words, the order may be interchanged if there are no restrictions, such as a relationship in which one step uses the results of the preceding step in a certain step. The above is true not only in this form, but also in other forms.

The receiver 101 receives a “packet” generated by the source device 10 (an example of the “first device”) (S101). The packet identification unit 102 identifies the chunk to which the packet received by the receiver 101 belongs (S102). Buffer 104 stores packets received by receiver 101 (S103). The communication performance acquisition unit 105 acquires the communication performance of each of the plurality of the communication lines (S104). The transmission control unit 106 assigns each of the plurality of packets to one of the plurality of communication lines for each chunk so that the time required for all of the plurality of packets belonging to the chunk to reach the second device is the shortest, based on the communication performance obtained at the communication performance acquisition unit 105 (S105). The transmitter 107 reads packets from the buffer 104 and transmits them to the destination device 20 (corresponding to the “second device”) using one of the plurality of communication lines based on the assignment of the transmission control unit 106 (S106).

According to the above explained embodiment, each chunk is transmitted by allocating each of the multiple packets belonging to that chunk to one of the plurality of communication lines, which enables efficient data transmission so that data can be used more quickly on the side of the destination device 20 or server device 15.

### 2. Modification of the First Embodiment

### (1) A First Modification

In the first embodiment, for each chunk, multiple packets belonging to the chunk are assigned to the communication line. However, there are cases in which not all packets belonging to a chunk are stored in buffer 104 due to buffer 104 overflow or other reasons. Therefore, in this modification, the storing of packets into the buffer and discarding from the buffer are controlled in units of chunks.

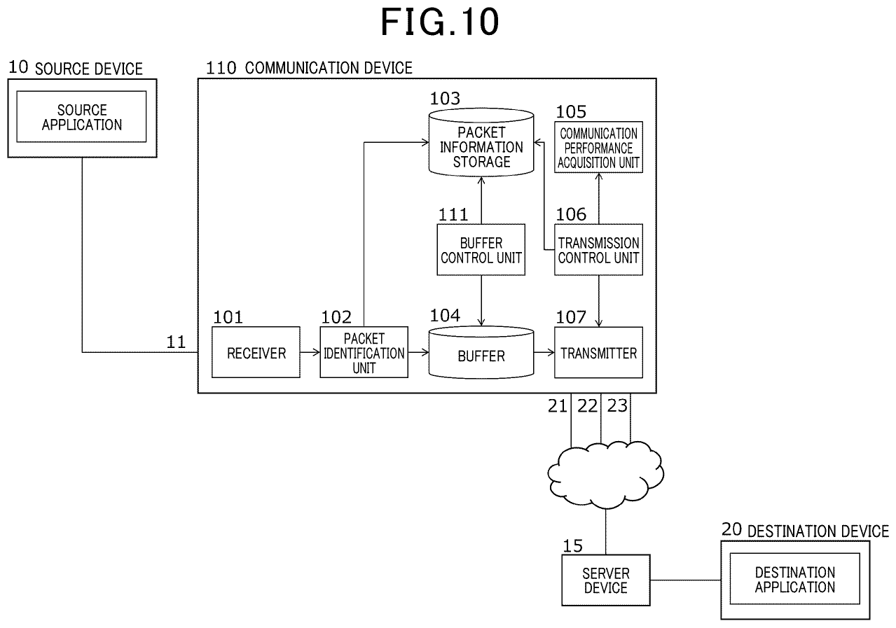

FIG. 10 illustrates the configuration of the communication device 110 of a first modification of the first embodiment. The communication device 110 has a buffer control unit 111 in addition to the configuration of the communication device 100 of the first embodiment shown in FIG. 1. The same reference numerals as in FIG. 1 are used for the same functions as those in the first embodiment, and the explanation of the first embodiment is quoted.

The buffer control unit 111 controls the storing of packets into the buffer 104 and the discarding of packets from the buffer 104. Specifically, when buffer 104 overflows, etc., the buffer control unit 111 deletes all packets belonging to old chunks based on packet information stored in packet information storage 103 or deletes some packets that are only partially stored out of all packets belonging to a chunk when an overflow occurs. When an overflow occurs, the buffer control unit 111 deletes all packets belonging to old chunks from the buffer 104 based on the packet information stored in the packet information storage 103 or deletes some packets that are only partially stored out of all packets belonging to a chunk from the buffer 104, and thereby controls packet storage and destruction “in units of one chunk”. “in units of one chunk” means that storing to and discarding from a buffer should result in a unit of a chunk, and it is not necessary to store all packets belonging to the same chunk at the same time when storing to a buffer, nor is it necessary to discard all packets belonging to the same chunk at the same time when discarding from a buffer. When storing to a buffer, it is not necessary to store all packets belonging to the same chunk at the same time.

According to the above modification of the first embodiment, since the packets are stored and discarded in chunk units, it is possible to prevent packets belonging to chunks with missing packets from being transmitted and realize efficient data transmission.

### 3. The Second Embodiment

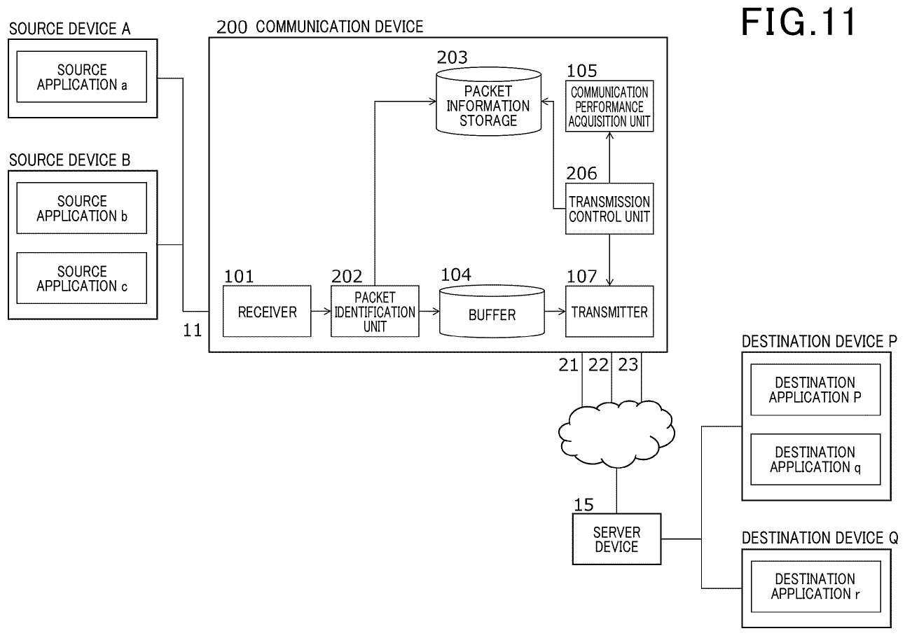

In the first embodiment, chunk identification was performed without distinguishing between connected source device 10 and destination device 20, or between the source and destination applications installed in the respective device. However, when multiple source terminal devices 10 and destination devices 20 are connected, it is necessary to treat each chunk as a different chunk even if they use the same software. Also, if multiple source applications or multiple destination applications are running on the source terminal device 10 or destination device 20, it is necessary to distinguish chunks for each application. The case of multiple connected source terminal devices 10 and destination devices 20, or multiple source and destination applications on each device, is explained in the second embodiment referencing FIG. 11. The same reference numerals as in FIG. 1 are used for the same functions as those in the first embodiment, and the explanation of the first embodiment is referred to.

FIG. 11 illustrates the configuration of communication device 200 in the second embodiment. The communication device 200 includes a receiver 101, a packet identification unit 202, a packet information storage 203, a buffer 104, a communication performance acquisition unit 105, a transmission control unit 206, and a transmitter 107.

A source terminal device A and a source terminal device B, which are multiple of source terminal devices, are connected to the communication device 200. Also, multiple of destination devices, destination device P and destination device Q, are connected to the communication device 200. The source terminal device A is equipped with and executes the source application a. The source terminal device B is equipped with and executes the source application b and the source application c. The destination device P is equipped with and executes the destination application p and the destination application q. The destination device P is equipped with and executes the destination application p and the destination application q. The destination device Q is equipped with and executes the destination application r. Three or more source and destination devices may be connected. Three or more source and destination applications may also be installed and executed on a single device.

In addition to identifying chunks as described in the first embodiment, the packet identification unit 202 further identifies the communication flow to which the packet belongs based on the source and/or destination of the packet.

A communication flow can include, for example, information identifying the source and the destination. For example, if a packet is sent from source application a of source terminal device A to destination application q of destination device P, the communication flow can be expressed as AaPq.

If only one source terminal device is connected to the communication device 200, information identifying the source terminal device can be omitted. If only one destination device is connected to the communication device 200, information identifying the destination device can be omitted. For example, if the only a source terminal device B is connected to communication device 200 as the source terminal device, the communication flow can be expressed as bPq when a packet is sent from source application b in source terminal device B to destination application q in destination device P. If only one source application is installed in the source device or one destination application is installed in the destination device, the information identifying the source or destination application can be omitted. For example, if the only source terminal device A is connected to communication device 200 as the source terminal device, and the only source application a is installed in source terminal device A as the source application, the communication flow can be expressed as Pq when a packet is sent from source application a in source terminal device A to destination application q in destination device P.

To identify the source and destination, information stored in the IP header and TCP/UDP header can be used.

As FIG. 4 shows, since the IP header contains the source and destination addresses, it is possible to identify the source and destination devices based on the IP header. In addition, since the IP header contains the protocol, it is possible to identify the protocol information used by the source and destination applications based on the IP header.

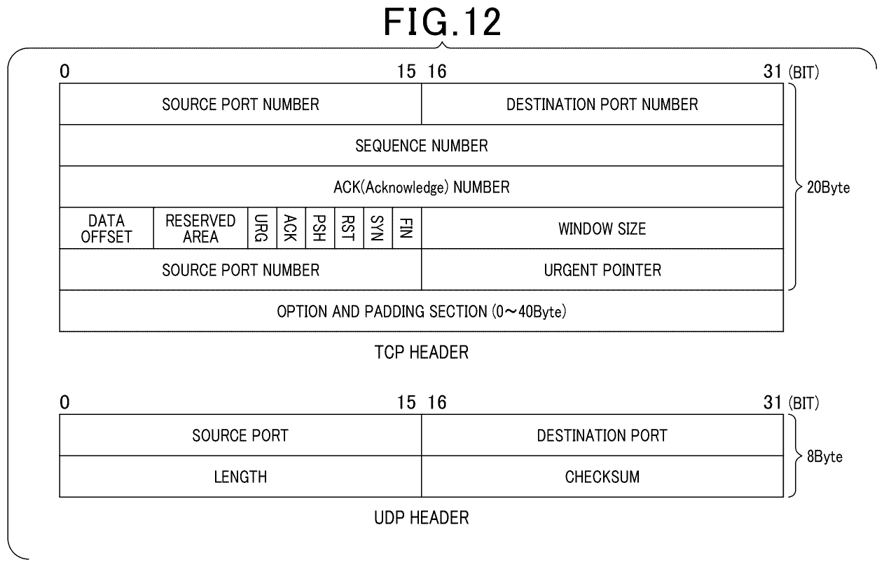

As FIG. 12 shows, since the source and destination port number are stored in the TCP and UDP headers, it is possible to identify the source and destination applications based on TCP and UDP headers.

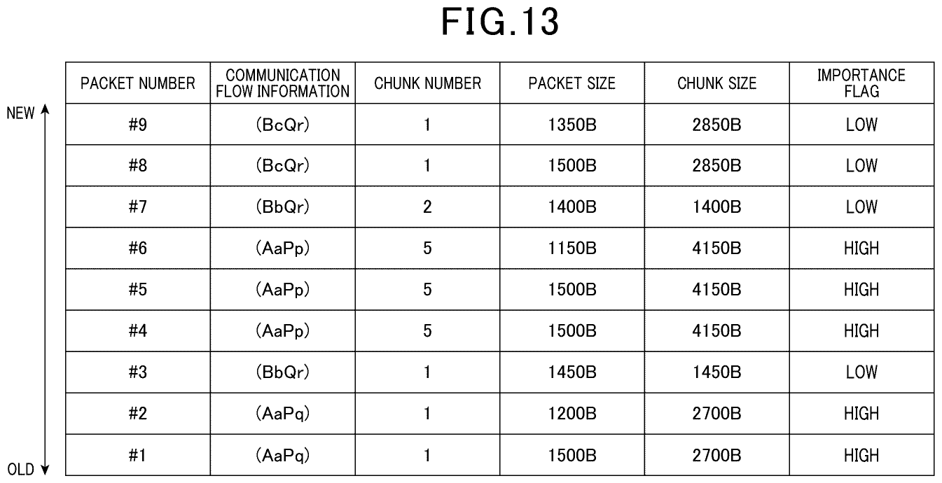

FIG. 13 shows the packet information stored in the packet information storage 203. As FIG. 13 shows, the packet information storage 203 stores communication flow information in addition to the packet information described in the first embodiment. The method of expressing communication flow is as described above.

In addition to the information shown in FIG. 13, the packet information storage 203 may further store the last received time of packets for each flow for the case where chunks of each flow are identified based on the interval of packet reception.

The transmission control unit 206 determines which one of the plurality of communication lines is used to transmit the packets stored in the buffer 104. In this embodiment, based on the communication performance acquired by the communication performance acquisition unit 105, for each communication flow and each chunk, the transmission control unit 206 assigns the each packet belonging to a chunk which should be sent to the server device 15 or the destination device 20 (whichever is an example of “second device”) to one of the plurality of communication lines, “so that the arrival time of the packet is the earliest”. For example, in FIG. 13, communication flow AaPq and communication flow BbQr are treated as different chunks even though they have the same chunk number 1.

According to the second embodiment, in addition to the configuration of the first embodiment, in each communication flow and each chunk, each of the multiple packets belonging to that chunk is assigned to one of the plurality of communication lines for transmission, data can be used more quickly and efficiently at the destination device 20 or server device 15.

### 4. Other Embodiments

When transmitting a packet, each of the transmitter 107 of the communication device 100 of the first embodiment, the communication device 110 of the modification of the first embodiment, and the communication device 200 of the second embodiment may transmit chunk identification information that identifies the chunk to which the packet belongs, either included in the packet or separately from the packet. For example, the chunk number in FIG. 2 and/or the chunk number and communication flow information in FIG. 13 may be transmitted. By transmitting chunk identification information, the chunk to which the received packet belongs can be identified by the server device 15 or the destination device 20. Also, it is possible to detect the arrival of a new chunk by the server device 15 or the destination device 20.

When transmitting a packet, the transmitter 107 of the communication device 100 of the first embodiment, the communication device 110 of the modification of the first embodiment, and the communication device 200 of the second embodiment may transmit chunk size information indicating the size of the chunk to which the packet belongs, either included in the packet or separately from the packet. For example, the chunk size shown in FIG. 2 and FIG. 13 may be transmitted. By sending chunk size information, it is possible to detect whether all packets belonging to a chunk have been received on the part of the server device 15 or the destination device 20, and it is also possible to detect the arrival of a new chunk on the part of the server device 15 or the destination device 20.

Based on specific chunk identification information and chunk size information, it is also possible to detect by the server device 15 or destination device 20 that the communication device 100 has discarded or ceased transmission of packets belonging to a chunk.

### 5. Specific Examples of Combinations of Source Device, Communication Device, and Destination Device

Some examples of specific combinations of source device 10, communication device 100 (110, 200), and destination device 20 will be shown.

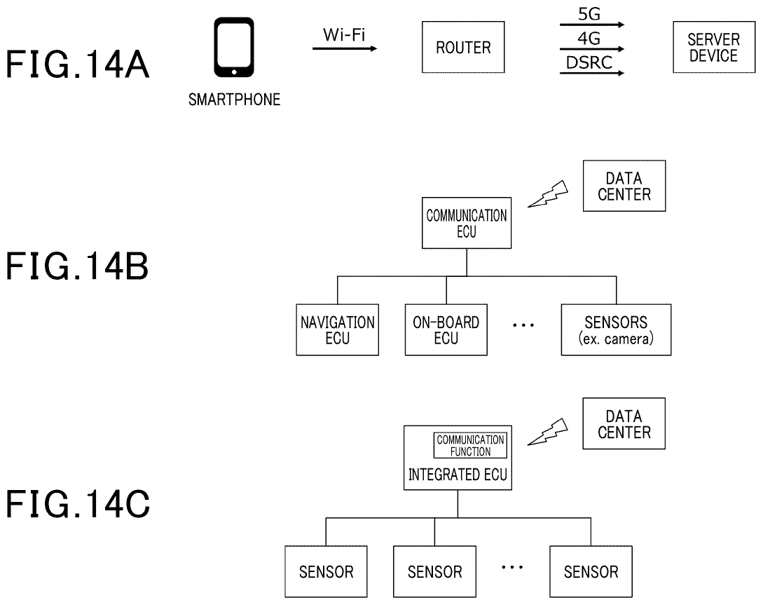

FIG. 14A shows a first specific example of combinations of source device, communication device, and destination device. As shown in FIG. 14A, when a video captured by a smartphone is sent to a router via Wi-Fi and uploaded from the router to a server device using a 4G line, 5G line, or DSRC, the smartphone is the source terminal device 10 (an example of a “first device”), the router is the communication device 100 (110, 200), and the server device is the destination device 20 (an example of a “second device”).

FIG. 14B shows a second specific example of combinations of source device, communication device, and destination device. The communication devices 100 (110, 200) may be “mounted” on a “mobile vehicle”. As shown in FIG. 14B, when data from ECUs and various sensors connected to the in-vehicle network is transmitted to the data center via a wireless communication method via a communication ECU, the navigation ECU, in-vehicle ECU, and various sensors are the source terminal device 10 (an example of “first device”), the communication ECU is the communication device 100 (110, 200), and the data center is the destination device 20 (an example of “second device”). FIG. 14C shows a third specific example of combinations of source device, communication device, and destination device. As shown in FIG. 14C, when data from various sensors connected to the in-vehicle network is transmitted to the data center by wireless communication method via the communication function of the integrated ECU, the various sensors are the source terminal devices 10 (corresponding to “first devices”), the integrated ECU is the communication devices 100 (110, 200), and the data center is the destination device 20 (an example of “second devices”), The integrated ECU is the communication device 100 (110, 200), and the data center is the destination device 20 (an example of a “second device”). A “mobile object” is an object that can move, and the speed at which it moves is arbitrary. It also includes, of course, the case where a mobile object is stationary. Examples include, but are not limited to, automobiles, motorcycles, bicycles, pedestrians, ships, aircraft, and their mountings. The term “mounted” includes cases where the device is directly fixed to a mobile object as well as cases where the device is not fixed to a mobile object but moves with the mobile object. For example, it may be carried by a person on the mobile object, or it may be mounted on a load placed on the mobile object.

### 6. Overall Summary

The features of the communication devices and other devices in each of the embodiments of this disclosure have been described above. The terms used in each embodiment are examples and may be replaced with terms that are synonymous or include synonymous functions.

The block diagram used to describe the implementation is a classification and organization of the device configuration by function. The blocks that indicate each function are realized by any combination of hardware or software. Since the block diagrams indicate functions, they can also be understood as disclosing the invention of a method and a program to realize the method.

The order of the processes, flows, and blocks, which can be understood as methods, described in each form, may be rearranged, as long as there are no restrictions, such as a relationship in which one step uses the results of the other step preceding it.

The communication devices of the present disclosure may be for vehicular applications or include dedicated or general-purpose communication devices other than for vehicular applications, except as specifically limited in the scope of the claims.

Examples of the forms of communication devices in this disclosure include semiconductor devices, electronic circuits, communication modules, and microcomputers. Semi-finished products include electronic control units (ECU (Electric Control Unit)) and system boards. The finished product may take the form of a mobile router, cell phone, smartphone, tablet, personal computer (PC), workstation, or server. Other forms of finished products include devices with communication functions, e.g., vehicle navigation systems.

It is contemplated that the communication devices of the present disclosure will be used for the purpose of providing various services. In conjunction with the provision of such services, the communication device of the present disclosure will be used, the communication method of the present disclosure will be used, and/or the communication program of the present disclosure will be executed.

In addition, this disclosure can be realized not only with dedicated hardware having the configuration and functions described in each embodiment, but also with a program for realizing this disclosure recorded on a recording medium such as a memory or hard disk, and with general-purpose hardware having a dedicated or general-purpose CPU and memory, etc. capable of executing it. This can also be realized as a combination of such items.

The program for the communication device of this disclosure, which is stored in a non-transitory substantive recording medium (e.g., external storage device (hard disk, USB memory, CD/BD, etc.) or internal storage device (RAM, ROM, etc.)) of dedicated or general-purpose hardware, can be provided via a recording medium or the program can also be provided from the server to dedicated or general-purpose hardware via communication lines without the need for the server. This allows the latest functions to be constantly provided through program upgrades.

The communication devices of this disclosure can be used for both automotive and non-automotive applications. Furthermore, it can also be applied to relay devices.

What is claimed is:

1. A communication device that transmits packets received from a first device to a second device using one of a plurality of communication lines, the device comprising:
a receiver that receives the packets from the first device;
a packet identification unit that identifies a chunk to which each of the packets belongs, the chunk being a unit of data treated as a single piece of data at a higher layer;
a buffer to store the packets;
a communication performance acquisition unit that acquires a communication performance of each of the plurality of the communication lines;
a transmission control unit, that assigns, for each of the chunks, each of the plurality of the packets to respective one of the plurality of the communication lines based on the communication performance, to make the arrival time of the plurality of packets as the whole chunk to the second device the earliest; and
a transmitter that reads the packets from the buffer and transmits the read packets to the second device using one of a plurality of the communication lines based on the assignment by the transmission control unit.

2. The communication device according to claim 1,
wherein the packet identification unit identifies the chunks based on the reception interval of the packets received by the receiver.

3. The communication device according to claim 2,
wherein the chunks are frames generated by compression of video.

4. The communication device according to claim 1,
wherein the packet identification unit identifies the chunks based on the identifier contained in the IP header of the packet.

5. The communication device according to claim 1,
wherein the packet identification unit identifies the chunk based on the identification information contained in the TCP/UDP payload of the packet.

6. The communication device according to claim 1,
wherein the transmission control unit assigns, for each of the chunks, each of the plurality of the packets to one of the plurality of the communication lines based on at least one of the available bandwidth of each communication line and the delay time of each communication line.

7. The communication device according to claim 1,
wherein the transmission control unit assigns, for each of the chunks, each of the plurality of the packets to respective one of the plurality of the communication lines based on at least one of the amount of un-transmitted data in the chunk being transmitted, and the amount of in-flight data, the in-flight data being data that is being transmitted or scheduled to be transmitted on each communication line and has not reached the second device, in addition to the communication performance.

8. The communication device according to claim 6,
wherein the transmission control unit assigns, for each of the chunks, each of the plurality of the packets to respective one of the plurality of the communication lines based on at least one of the amount of un-transmitted data in the chunk being transmitted, and the amount of in-flight data, the in-flight data being data that is being transmitted or scheduled to be transmitted on each communication line and has not reached the second device, in addition to the communication performance.

9. The communication device according to claim 1,
wherein the transmitting unit, when transmitting a subsequent packet using the communication line to which no preceding packet is assigned, reads the subsequent packet from the from a position offset from a beginning of the buffer,
the preceding packet is a packet of a preceding chunk, which is a chunk that should complete reaching the second device first, and
the subsequent packet is a packet of a subsequent chunk, which is a chunk that should complete reaching the second device after the preceding chunk.

10. The communication device according to claim 1, further comprising,
a buffer control unit that controls the storage of the packets in the buffer and the discarding of the packets from the buffer by the chunks.

11. The communication device according to claim 1,
wherein the packet identification unit identifies a communication flow to which the packet belongs based on the source and/or destination of the packet,
the transmission control unit assigns each of the plurality of packets to respective one of the plurality of communication lines for each communication flow and for each chunk, to make the arrival time of the plurality of packets by the chunk to the second device the earliest.

12. The communication device according to claim 1,
wherein the transmitter transmits chunk identification information that identifies the chunk to which the packet belongs.

13. The communication device according to claim 1,
wherein the transmitter transmits chunk size information indicating the size of the chunk to which the packet belongs.

14. The communication device according to claim 1,
wherein the communication device is mounted to a mobile object.

15. A communication method executed by a communication device that transmit packets received from a first device to a second device using one of a plurality of communication lines, the method comprising:
receiving the packets from the first device;
identifying the chunk to which each of the packets belongs, the chunk being a unit of data treated as a single piece of data at a higher layer;
storing the packets in a buffer;
acquiring the communication performance of each of a plurality of the communication lines;
assigning, for each of the chunks, each of a plurality of the packets to respective one of a plurality of the communication lines based on the communication performance, to make the arrival time of the plurality of packets as the whole chunk to the second device the earliest; and
reading the packets from the buffer and transmitting the read packets to the second device using one of a plurality of the communication lines based on the assignment.

16. A computer-readable non-transitory storage medium storing a communication program executable by a communication device that transmits packets received from a first device to a second device using one of a plurality of communication lines, the communication program causing the communication device to:
receive the packets from the first device;
identify the chunk to which each of the packets belongs, the chunk being a unit of data treated as a single piece of data at a higher layer;
store the packets in a buffer;
acquire the communication performance of each of a plurality of the communication lines;
assign, for each of the chunks, each of a plurality of the packets to respective one of a plurality of the communication lines based on the communication performance, to make the arrival time of the plurality of packets as the whole chunk to the second device the earliest; and
read the packets from the buffer and transmitting the read packets to the second device using one of a plurality of the communication lines based on the assignment.
